(19) United States
(12) Patent Application Publication
(10) Pub. No.: US 2007/0127565 A1
(43) Pub. Date: Jun. 7, 2007

(54) Video encoding method and device

(76) Inventor: Stephan Oliver Mietens, Eindhoven (NL)

Correspondence Address: PHILIPS INTELLECTUAL PROPERTY & STANDARDS, P.O. BOX 3001, BRIARCLIFF MANOR, NY, 10510, US

(21) Appl. No.: 10/575,587

(22) PCT Filed: Oct. 11, 2004
(86) PCT No.: PCT/IB04/03327

§ 371 Date: Apr. 11, 2006

(30) Foreign Application Priority Data
Oct. 14, 2003 (EP) 003300155.3

(51) Int. Cl. H04N 11/04; H04N 11/02

(52) U.S. Cl. 375/240.03; 375/240.16

(57) ABSTRACT

The invention relates to a video encoding method provided for encoding each frame of a sequence of successive groups of frames. This method comprises for each successive current frame, itself subdivided into blocks, the steps of estimating a motion vector for each block, generating a predicted frame from these motion vectors, applying to a difference signal between the current frame and the last predicted frame a transformation and quantization sub-step, and coding the quantized coefficients thus obtained. A preprocessing step, applied to each successive current frame, computes for said frame a so-called content-change strength (CCS), used to define a modified structure of the successive groups of frames to be encoded.

### FIELD OF THE INVENTION

The present invention relates to a video encoding method provided for encoding an input image sequence consisting of successive groups of frames, said method comprising for each successive frame, called current frame and subdivided into blocks, the steps of:
estimating a motion vector for each block of the current frame;
generating a predicted frame using said motion vectors respectively associated to the blocks of the current frame;
applying to a difference signal between the current frame and the last predicted frame a transformation sub-step producing a plurality of coefficients and followed by a quantization sub-step of said coefficients;
coding said quantized coefficients.

Said invention is for instance applicable to video encoding devices that require reference frames for reducing e.g. temporal redundancy (like motion estimation and compensation devices). Such an operation is part of current video coding standards and is expected to be similarly part of future coding standards also. Video encoding techniques are used for instance in devices like digital video cameras, mobile phones or digital video recording devices. Furthermore, applications for coding or transcoding video can be enhanced using the technique according to the invention.

### BACKGROUND OF THE INVENTION

In video compression, low bit rates for the transmission of a coded video sequence may be obtained by (among others) a reduction of the temporal redundancy between successive pictures. Such a reduction is based on motion estimation (ME) and motion compensation (MC) techniques. Performing ME and MC for the current frame of the video sequence however requires reference frames (also called anchor frames). Taking MPEG-2 as an example, different frames types, namely I-, P- and B-frames, have been defined, for which ME and MC are performed differently: I-frames (or intra frames) are independently coded, by themselves, without any reference to past or future frames (i.e. without any ME and MC), while P-frames (or forward predicted pictures) are encoded each one relatively to a past frame (i.e. with motion compensation from a previous reference frame) and B-frames (or bidirectionally predicted frames) are encoded relatively to two reference frames (a past frame and a future frame). The I- and P-frames serve as reference frames.

In order to obtain good frame predictions, these reference frames need to be of high quality, i.e. many bits have to be spent to code them, whereas non-reference frames can be of lower quality (for this reason, a higher number of non-reference frames, B-frames in the case of MPEG-2, generally lead to lower bit rates). In order to indicate which input frame is processed as an I-frame, a P-frame or a B-frame, a structure based on groups of pictures (GOPs) is defined in MPEG-2. More precisely, a GOP uses two parameters N and M, where N is the temporal distance between two I-frames and M is the temporal distance between reference frames. For example, an (N,M)-GOP with N=12 and M=4 is commonly used, defining an “I B B B P B B B P B B B” structure.

Succeeding frames generally have a higher temporal correlation than frames having a larger temporal distance between them. Therefore shorter temporal distances between the reference and the currently predicted frame on the one hand lead to higher prediction quality, but on the other hand imply that less non-reference frames can be used. Both a higher prediction quality and a higher number of non-reference frames generally result in lower bit rates, but they work against each other since the frame prediction quality results from shorter temporal distances only.

However, said quality also depends on the usefulness of the reference frames to actually serve as references. For example, it is obvious that with a reference frame located just before a scene change, the prediction of a frame located just after the scene change is not possible with respect to said reference frame, although they may have a frame distance of only 1. One the other hand, in scenes with a steady or almost steady content (like video conferencing or news), even a frame distance of more than 100 can still result in high quality prediction.

From the above-mentioned examples, it appears that a fixed GOP structure like the commonly used (12, 4)-GOP may be inefficient for coding a video sequence, because reference frames are introduced too frequently, in case of a steady content, or at a unsuitable position, if they are located just before a scene change. Scene-change detection is a known technique that can be exploited to introduce an I-frame at a position where a good prediction of the frame (if no I-frame is located at this place) is not possible due to a scene change. However, sequences do not profit from such techniques if the frame content is almost completely different after some frames having high motion, with however no scene change at all (for instance, in a sequence where a tennis player is continuously followed within a single scene).

### SUMMARY OF THE INVENTION

It is therefore the object of the invention to propose a method for finding good frames that can serve as reference frames in order to reduce the coding cost for the predicted frames.

To this end, the invention relates to a preprocessing method such as defined in the introductory paragraph of the description and in which a preprocessing step is applied to each successive current frame, said preprocessing step itself comprising the sub-steps of:
a computing sub-step, provided for computing for each frame a so-called content-change strength (CCS);
a defining sub-step, provided for defining from the successive frames and the computed content-change strength the structure of the successive groups of frames to be encoded;
a storing sub-step, provided for storing the frames to be encoded in an order modified with respect to the order of the original sequence of frames.

The invention also relates to a device for implementing said method.

The article “Rate-distortion optimized frame type selection for MPEG encoding”, J. Lee et al., IEEE Transactions on Circuits and Systems for Video Technology, vol.7, n°3, June 1997, describes an algorithm which also allows to dynamically obtain an optimization of GOP structures. However, for finding the optimal number and positions of the reference frames, the problem as described is formulated using the Lagrangian multiplier technique, and its solution is based on simulated annealing, which is an extremely costly technique, requiring a very noticeable computational complexity and memory.

### BRIEF DESCRIPTION OF THE DRAWINGS

The present invention will now be described, by way of example, with reference to the accompanying drawings in which:

FIG. 1 illustrates the rules used for defining according to the invention the place of the reference frames of the video sequence to be coded;

FIG. 2 illustrates an encoder carrying out the encoding method according to the invention, taking the MPEG-2 case as an example;

FIG. 3 shows an encoder carrying out said encoding method, but incorporating another type of motion estimator.

### DETAILED DESCRIPTION OF THE INVENTION

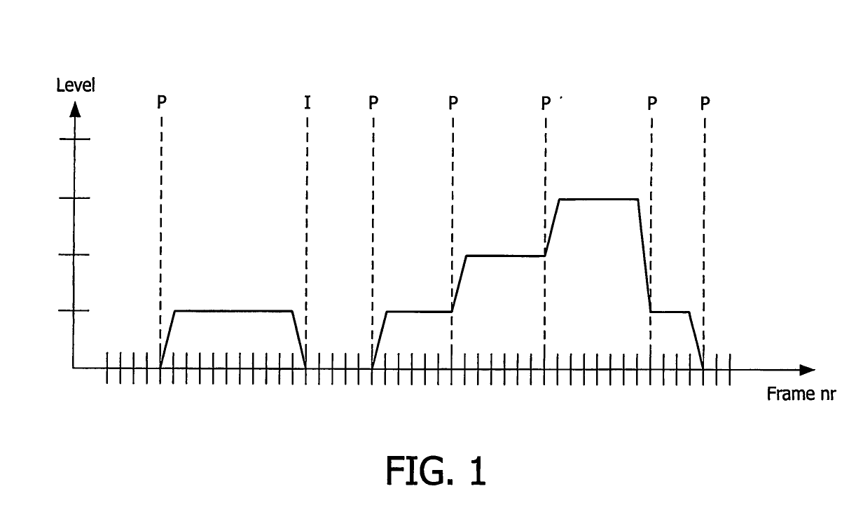

The invention relates to an encoding method in which a preprocessing step allows to find which frames in the sequence can serve as reference frames, in order to reduce the coding cost for the predicted frames. The search for these good frames goes beyond the limitation of detecting scene-changes only and aims at grouping frames having similar contents. More precisely, the principle of the invention is to measure the strength of content change on the basis of some simple rules. These rules are listed below and illustrated in FIG. 1, where the horizontal axis corresponds to the number of the concerned frame (Frame nr) and the vertical axis to the level of the strength of content change:
(a) the measured strength of content change is quantized to levels (preliminary experiments have shown that a small number of levels, up to 5, seem sufficient, but the number of levels cannot be a limitation of the invention);
(b) I-frames are inserted at the beginning of a sequence of frames having content-change strength (CCS) of level 0;
(c) P-frames are inserted before a level increase of CCS occurs, in order to use the recent most content-stable frame as reference;
(d) P-frames are inserted after a level decrease of CCS occurs for the same reason.

Concerning the measure itself, it is preferred that the measuring allows an on-the-fly adaptation of the GOP structure, i.e. the decision about the type of a frame can be made latest after the subsequent frame is analyzed (it can be noted that because encoders do not have unlimited memory available that would be required for real-time video coding without limiting the allowed GOP size, reference frames can be inserted anytime depending on the application policies). An example can be given: if the measure is for instance a simple block classification that detects horizontal and vertical edges (other measures can be based on luminance, motion vectors, etc.), the CCS is derived in a preliminary experiment by comparing the block classes that have been found for two succeeding frames and counting the features “detected horizontal edge” or “detected vertical edge” that do not remain constant in a block. Each non-constant feature counts (100)/(2*8*b) for the CCS number, where b is the number of blocks in the frame. In this example, CCS ranges from 0 to 6. The experiment made for this example also includes a simple filter that outputs a new CCS number not before it was stable for 3 frames. This filter seemed advantageous especially in the case of switching from motion to standstill, where a sharp picture that should be used for I-frames was delayed for three frames, although no content change was detected. Despite the filter, an increase of the CCS number of 2, compared to the previous number, is seen as strong enough to be processed without filtering.

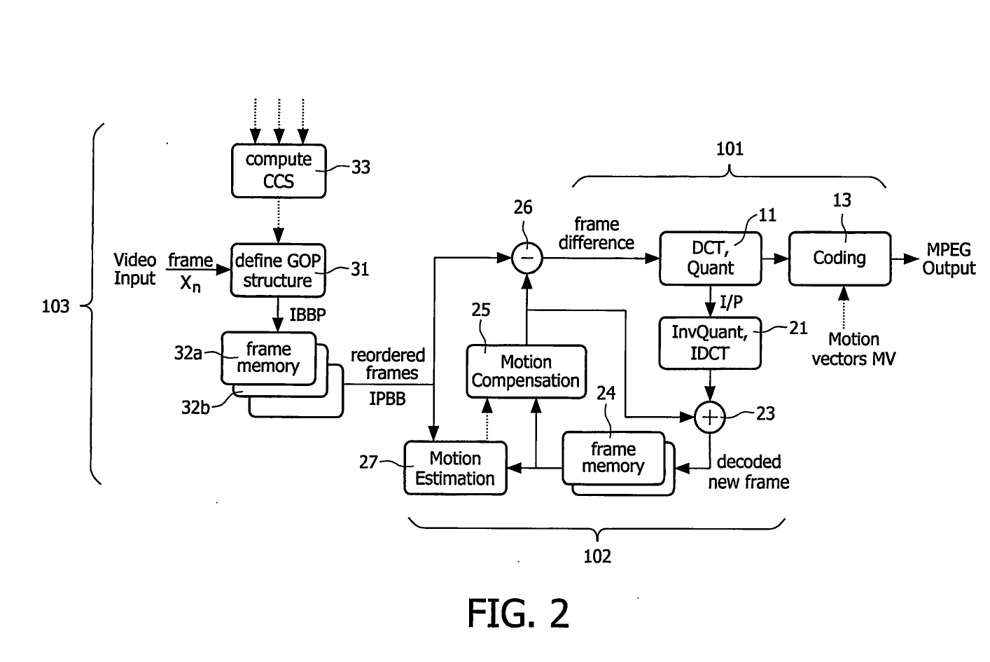

An implementation of the method according to the invention in the MPEG encoding case is now described in FIG. 2. An MPEG-2 encoder usually comprises a coding branch 101 and a prediction branch 102. The signals to be coded, received by the branch 101, are transformed into coefficients and quantized in a DCT and quantization module 11, and the quantized coefficients are then coded in a coding module 13, together with motion vectors MV generated as explained below. The prediction branch, receiving as input signals the signals available at the output of the DCT and quantization module 11, comprises in series an inverse quantization and inverse DCT module 21, an adder 23, a frame memory 24, a motion compensation (MC) circuit 25 and a subtracter 26. The MC circuit 25 also receives the motion vectors MV, generated by a motion estimation (ME) circuit 27 from the input reordered frames (defined as explained below), and the output of the frame memory 24, and these motion vectors are also sent towards the coding module 13, the output of which (“MPEG output”) is stored or transmitted in the form of a multiplexed bitstream.

According to the invention, the video input of the encoder (successive frames Xn) is preprocessed in a preprocessing branch 103 which is now described. First a GOP structure defining circuit 31 is provided for defining from the successive frames the structure of the GOPs. Frame memories 32a, 32b, . . . are then provided for reordering the sequence of I, P, B frames available at the output of the circuit 31 (the reference frames must be coded and transmitted before the non-reference frames depending on said reference frames). These reordered frames are sent on the positive input of the subtracter 26 (the negative input of which receives, as described above, the output predicted frames available at the output of the MC circuit 25, these predicted frames being also sent back to a second input of the adder 23). The output of the subtracter 26 delivers frame differences that are the signals processed by the coding branch 101. For the definition of the GOP structure, a CCS computation circuit 33 is provided. The measure of said CCS is for example obtained as indicated above with reference to FIG. 1, but other examples may be given.

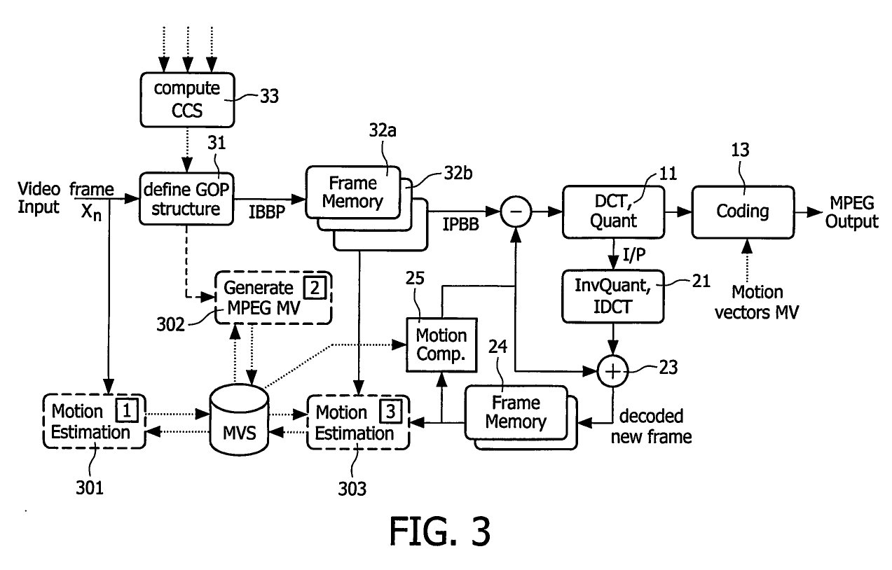

It may be noted that the invention, here described in the case of a conventional MPEG motion estimator using the classical block-matching algorithm (BMA), cannot be limited by such an implementation. Other implementations of motion estimators may be proposed without being out of the scope of this invention, and for instance the motion estimator described in “New flexible motion estimation technique for scalable MPEG encoding using display frame order and multi-temporal references”, S. Mietens and al., IEEE-ICIP 2002, Proceedings, Sep. 22-25, 2002, Rochester, USA, pp.I 701 to 704. An encoder incorporating this motion estimator is depicted in FIG. 3, in which similar circuits are designated by the same references as in FIG. 2. The modifications concern the three circuits indicated by the numbers 1, 2 and 3: the two additional function blocks 301 and 302, and the block 303 which is modified with respect to the ME circuit 27 in FIG. 2. The first block 301 receives frames directly from the input in display order and performs a motion estimation (ME) on these consecutive frames. Hereby, the ME results in highly accurate motion vectors, because of the small frame distance and by using unmodified frames. The motion vectors are stored in a memory MVS. The second block 302 approximates the motion vector fields that are required for MPEG coding by linear combinations of the vector fields that are stored in the memory MVS. The third block 303 is optionally activated for refining the vector fields generated in the block 302 by another ME process. The ME circuit 27 in FIG. 2 (as well as the block 303 in FIG. 3) usually uses the frames that already went via the branches DCT, Quantization (Quant), Dequantization (InvQuant) and IDCT and therefore are reduced in quality and hampering accurate ME. However, since the block 303 reuses the approximations from the block 302, the refined vector fields are more accurate than the vector fields computed by the ME circuit 27 of FIG. 2. The function block “define block structure” decides over the GOP structure based on the data received from block “compute CCS” as described in the present invention disclosure. As described earlier, the measure of content-change strength can be based on one or several types of information (block classification, luminance, motion vectors, . . . ), and the block “compute CCS” may have therefore different inputs for computing the change-content strength (CCS).

1. A video encoding method provided for encoding an input image sequence consisting of successive groups of frames, said method comprising for each successive frame, called current frame and subdivided into blocks, the steps of:
estimating a motion vector for each block of the current frame;
generating a predicted frame using said motion vectors respectively associated to the blocks of the current frame;
applying to a difference signal between the current frame and the last predicted frame a transformation sub-step producing a plurality of coefficients and followed by a quantization sub-step of said coefficients;
coding said quantized coefficients;
wherein a preprocessing step is applied to each successive current frame, said preprocessing step itself comprising the sub-steps of:
a computing sub-step, provided for computing for each frame a so-called content-change strength (CCS);
a defining sub-step, provided for defining from the successive frames and the computed content-change strength the structure of the successive groups of frames to be encoded;
a storing sub-step, provided for storing the frames to be encoded in an order modified with respect to the order of the original sequence of frames.

2. An encoding method according to claim 1, in which said CCS is defined on the basis of the following rules:
(a) the measured strength of content change is quantized to levels;
(b) I-frames are inserted at the beginning of a sequence of frames having content-change strength (CCS) of level 0;
(c) P-frames are inserted before a level increase of CCS occurs;
(d) P-frames are inserted after a level decrease of CCS occurs.

3. A video encoding device provided for encoding an input image sequence consisting of successive groups of frames, said device comprising the following means, applied to each successive frame, called current frame and subdivided into blocks:
estimating means, provided for estimating a motion vector for each block of the current frame;
generating means, provided for generating a predicted frame on the basis of said motion vectors respectively associated to the blocks of the current frame;
transforming and quantizing means, provided for applying to a difference signal between the current frame and the last predicted frame a transformation producing a plurality of coefficients and followed by a quantization of said coefficients;
coding means, provided for encoding said quantized coefficients;
wherein said encoding device also comprises preprocessing means applied to each successive current frame and comprising itself the following means:
computing means, provided for computing for each frame a so-called content-change strength (CCS);
defining means, provided for defining from the successive frames and the computed content-change strength the structure of the successive groups of frames to be encoded;
storing means, provided for storing the frames to be encoded in an order modified with respect to the order of the original sequence of frames.

4. An encoding device according to claim 3, in which said CCS is defined on the basis of the following rules:
(a) the measured strength of content change is quantized to levels;
(b) I-frames are inserted at the beginning of a sequence of frames having content-change strength (CCS) of level 0;
(c) P-frames are inserted before a level increase of CCS occurs;
(d) P-frames are inserted after a level decrease of CCS occurs.
